(19) United States
(12) Patent Application Publication
(10) Pub. No.: US 2025/0148470 A1
(43) Pub. Date: May 8, 2025

(54) SYSTEMS AND METHODS FOR DYNAMICALLY UPDATING MODELS USING MACHINE LEARNING

(71) Applicant: MASTERCARD INTERNATIONAL INCORPORATED, Purchase, NY (US)

(72) Inventors: Joshua A. Allbright, Valley Park, MO (US); Christopher John Merz, Wildwood, MO (US)

(21) Appl. No.: 18/501,752

(22) Filed: Nov. 3, 2023

(51) Int. Cl. G06Q 20/40; G06N 20/00

(52) U.S. Cl. CPC G06Q 20/4016; G06N 20/00

(57) ABSTRACT

A computing system for detecting patterns in data transmitted over a network is provided. The computing system includes a model engine configured to receive an initial dataset including historical data for a first time period, and segment the initial dataset into a plurality of subsets, each subset associated with a second time period smaller than the first time period. The model engine is further configured to train a machine learning model on each subset separately, receive a candidate dataset, analyze the candidate dataset using the trained machine learning model, and assign a score to the candidate dataset based on the analysis. The computing system further includes a rules engine configured to receive the candidate dataset and the corresponding score from the model engine, and generate and output, based at least in part on the score, a decision regarding the candidate dataset.

### BACKGROUND

This disclosure relates generally to machine learning computer models and, more particularly, to computer systems and computer-based methods for dynamically updating such models.

Machine learning computer models are used in numerous industries and applications. For example, machine learning computer models may be used by payment processing networks to analyze electronic payment transactions.

Payment processing networks process numerous payment card transactions every day through numerous merchants. Most of these payment card transactions are valid transactions. However, at least some of these payment card transactions are fraudulent. Payment card transaction processors, such as payment networks and issuing banks, may monitor payment card transactions for signs of fraudulent activity. For example, electronic transaction data may be analyzed using one or more computer models to detect potentially fraudulent transactions.

Over time, fraudsters may change their tactics and/or the type of fraud attacks attempted. Accordingly, computer models for detecting fraud may be periodically updated (or trained) to keep up with changes in fraud patterns. However, there is generally a delay between when a computer model is updated, and when that computer model is “launched” to actively monitor payment card transactions for fraud. Further, updating a computer model using relatively recent transaction data may impair the ability of the computer model to accurately detect fraud, as fraud is often discovered some period of time after the actual transaction occurs. For example, a cardholder may not determine that a fraudulent transaction took place until reviewing their credit card statement days (or even weeks) after the transaction occurred. Accordingly, using recent, raw transaction data to update computer models for detecting fraud may negatively impact the performance of those models.

### BRIEF DESCRIPTION

In one aspect, a computing system for detecting patterns in data transmitted over a network is provided. The computing system includes a model engine configured to receive, from a database, an initial dataset including historical data for a first time period, and segment the initial dataset into a plurality of subsets, each subset associated with a second time period that is smaller than the first time period. The model engine is further configured to train a machine learning model on each subset of the plurality of subsets separately, receive, from a computing device, a candidate dataset, analyze the candidate dataset using the trained machine learning model, and assign a score to the candidate dataset based on the analysis. The computing system further includes a rules engine communicatively coupled to the model engine and configured to receive the candidate dataset and the corresponding score from the model engine, and generate and output, based at least in part on the score, a decision regarding the candidate dataset.

In another aspect, a computing system for detecting and preventing fraudulent network events in a payment card network is provided. The computing system includes a fraud model engine configured to receive, from a database, an initial dataset including historical transaction data for a first time period, and segment the initial dataset into a plurality of subsets, each subset associated with a second time period that is smaller than the first time period. The fraud model engine is further configured to train a fraud scoring model on each subset of the plurality of subsets separately, receive, from a merchant computing device, a payment card transaction request, analyze the payment card transaction request using the trained fraud scoring model, and assign a score to the payment card transaction request based on the analysis. The computing system further includes a fraud rules engine communicatively coupled to the fraud model engine and configured to receive the payment card transaction request and the corresponding score from the fraud model engine, and generate and output, based at least in part on the score, a decision whether to approve or decline a transaction associated with the payment card transaction request.

In yet another aspect, a computer-implemented method for detecting and preventing fraudulent network events in a payment card network is provided. The method includes receiving, at a fraud model engine, from a database, an initial dataset including historical transaction data for a first time period, segmenting the initial dataset into a plurality of subsets, each subset associated with a second time period that is smaller than the first time period, and training a fraud scoring model on each subset of the plurality of subsets separately. The method further includes receiving, from a merchant computing device, a payment card transaction request, analyzing the payment card transaction request using the trained fraud scoring model, and assigning a score to the payment card transaction request based on the analysis. The method further includes receiving, at a fraud rules engine communicatively coupled to the fraud model engine, the payment card transaction request and the corresponding score from the fraud model engine, and generating and outputting, based at least in part on the score, a decision whether to approve or decline a transaction associated with the payment card transaction request.

### BRIEF DESCRIPTION OF THE DRAWINGS

FIGS. 1-7 show example embodiments of the methods and systems described herein.

FIG. 1 is a simplified block diagram of an example fraud analysis computing system for detecting fraudulent activity in a payment card interchange network in accordance with one example embodiment of the present disclosure.

FIG. 2 is a schematic diagram illustrating an example multi-party payment card industry system for enabling ordinary payment-by-card transactions in which merchants and card issuers do not necessarily have a one-to-one relationship.

FIG. 3 is a simplified block diagram of the fraud analysis computing system shown in FIG. 1 in communication with the payment interchange network shown in FIG. 2 in accordance with one embodiment of the present disclosure.

FIG. 4 illustrates an example configuration of a client system shown in FIG. 3.

FIG. 5 illustrates an example configuration of a server system shown in FIG. 3.

FIG. 6 shows an example configuration of the fraud analysis computing system shown in FIG. 1.

FIG. 7 is a flow diagram of a computer-implemented merchant profiling method for detecting fraudulent activity in a payment card transaction network.

### DETAILED DESCRIPTION

Embodiments of the present disclosure describe a fraud detection computer device and method implemented using a computing system that is in communication with a fraud detection system and a data warehouse associated with a payment card network. The methods and systems described herein utilize one or more fraud detection models in real time.

Although at least some of the embodiments disclosed herein are described in the context of fraud analysis (and using machine learning computer models to identify fraudulent transactions), those of skill in the art will appreciate that the systems and methods described herein may be used to train machine learning computer models that are utilized in a wide variety of different industries and applications. That is, the model training techniques described herein are not limited to use with fraud detection computer models.

In an example embodiment, a fraud analysis computing system includes a fraud model engine. The fraud model engine is communicatively coupled to at least one database that stores transaction records, such as completed payment card transaction requests. The fraud model engine may additionally or alternatively be communicatively coupled to a plurality of merchants directly or through at least one merchant bank. The fraud analysis computing system further includes a fraud rules engine communicatively coupled to the database, and to the fraud model engine. In some embodiments, the fraud model engine and the fraud rules engine are implemented on the same computing platform. In alternative embodiments, each of the fraud model engine and the fraud rules engine are implemented on separate computing platforms and coupled together in electronic communication.

In the example embodiment, the fraud analysis computing system analyzes transaction data in real-time to determine whether transactions are potentially fraudulent, as described herein. More specifically, the fraud model engine is configured to receive one or more payment card transaction requests from one or more merchants. In various embodiments, the payment card transaction requests are received by the payment card interchange network and forwarded to the fraud model engine. The fraud model engine is configured to analyze each of the received payment card transaction requests on an individual basis (that is, without regard to characteristics of other incoming payment card transaction requests) for fraud, and to assign a fraud score to each of the payment card authorization requests.

In one example embodiment, the fraud model engine executes a fraud scoring model to analyze and score payment card transaction requests. The resulting fraud score is indicative of a likelihood of fraud being associated with a respective payment card transaction requests. In some embodiments, the fraud model engine includes or executes a plurality of machine learning algorithms, either separate from execution of the fraud scoring model or as part of the fraud scoring model. In various embodiments, the machine learning algorithms may be selectable, either automatically or by an operator, and may include at least one of an Artificial Neural Network (ANN) machine learning algorithm and a Support Vector Machine (SVM) machine learning algorithm. The fraud model engine may be configured to execute multiple machine learning algorithms singly or simultaneously in groups.

At least some scored payment card transaction requests are transmitted to the fraud rules engine for further analysis. The fraud rules engine applies one or more fraud rules to each scored payment card transaction request to facilitate determining whether or not the transaction is likely fraudulent. For example, the fraud rules may determine whether or not a transaction should be identified as fraudulent based on one or more of the score assigned by the fraud model engine, a dollar amount of the transaction, a location of the transaction (e.g., whether the transaction is a cross-border transaction), a merchant involved in the transaction, etc.

Based on the analysis undertaken by the fraud model engine and the fraud rules engine, the fraud analysis computing system generates an output for each payment card transaction request. The output may be, for example, a decision to approve or decline the transaction associated with payment card transaction request. In some embodiments, the output may include one or more scores (e.g., the fraud score assigned by the fraud scoring model). The output may be transmitted from the fraud analysis computing system (e.g., from the fraud model engine and/or the fraud rules engine) to one or more of the merchant, the merchant bank, and the issuer.

Over time, fraudsters may change their tactics and/or the type of fraud attacks attempted. Accordingly, computer models for detecting fraud may be periodically updated (or trained) to keep up with changes in fraud patterns. However, there is generally a delay between when a computer model is updated, and when that computer model is “launched” to actively monitor payment card transactions for fraud. Further, updating a computer model using relatively recent transaction data may impair the ability of the computer model to accurately detect fraud, as fraud is often discovered some period of time after the actual transaction occurs. For example, a cardholder may not determine that a fraudulent transaction took place until reviewing their credit card statement days (or even weeks) after the transaction occurred. Accordingly, using recent, raw transaction data to update computer models for detecting fraud may negatively impact the performance of those models.

As described in detail herein, to address these technical problems and improve performance for detecting fraudulent transactions, the fraud scoring model is trained incrementally. Specifically, instead of training a computer model all at once on a large dataset of historical transaction data covering a relatively long period of time (as is done in at least some known systems), the dataset of historical transaction data is segmented into multiple subsets of historical transaction data, and the fraud scoring model is trained on each subset separately. Further, in some embodiments, different subsets are weighted differently for training purposes based on their age.

In the example embodiment, the fraud model engine receives a payment card transaction request, and executes the fraud scoring model to analyze and score the payment card transaction request. The resulting fraud score is indicative of a likelihood of fraud for the payment card transaction request. For example, higher scores may indicate a higher likelihood of fraud.

In one embodiment, if the fraud score assigned by the fraud model engine falls below a threshold score, the payment card transaction request is approved without further analysis by the fraud model engine and the fraud rules engine. If the fraud score meets or exceeds the threshold score, the scored payment card transaction request is transmitted to the fraud rules engine for further analysis.

As noted above, there is generally a delay between when a computer model is trained or updated, and when that computer model is “launched” to actively monitor payment card transactions for fraud. In an ideal scenario, without such delays, at least some known computer models may detect approximately 20% of fraudulent transactions at a legitimate to fraudulent transaction ratio of 5:1 (i.e., 5 legitimate transactions are declined for every 1 fraudulent transaction that is declined). However, in reality, when the delay is implemented, at least some known computer models may only detect approximately 3% of fraudulent transactions.

Using a rules-based analysis avoids the delay issue associated with training computer models. However, a rules-based analysis typically detects fraud at a less desirable legitimate to fraudulent transaction ratio (e.g., declining 20 legitimate transactions for every 1 fraudulent transaction that is declined). Accordingly, improving the training of the computer models, as described herein, facilitates offsetting the reducing in performance due to the delay issue, and results in a more robust and efficient fraud detection platform.

In the example embodiment, the fraud scoring model is a machine learning model, and more particularly, a gradient-boosted decision tree model. For example, the model may be a scalable, distributed gradient-boosted decision tree model that uses supervised machine learning, ensemble learning, and gradient boosting. In supervised machine learning, algorithms are used to train a model to find patterns in a labeled dataset, and the trained model is then used to predict labels on a new dataset. Ensemble learning includes combining different machine learning algorithms to obtain an improved output. Further, as will be appreciated by those of skill in the art, gradient boosting involves additively generating and combining weak models to generate a strong model. More specifically, gradient-boosted decision tree models iteratively train an ensemble of decision trees, and each iteration uses the error of the previous tree to fit the subsequent tree.

Alternatively, the fraud scoring model may be any suitable model. For example, the fraud model engine may employ artificial intelligence and/or be trained using supervised or unsupervised machine learning.

As will be appreciated by those of skill in the art, gradient-boosted decision tree models build or generate a plurality of decision trees. The trees may be built sequentially or in parallel. Notably, errors or mistakes in at least some trees are used to train other trees. Further, as will be appreciated by those of skill in the art, each tree includes an initial root node, a plurality of branch nodes, and a plurality of leaf nodes.

In at least some known systems, to update computer models, the models are trained on relatively large dataset. For example, to update a fraud model, the fraud model may be trained using a dataset that includes historical transaction data covering a time period of one year. However, training the fraud model using a single, relatively large dataset may have drawbacks. For example, because the dataset includes historical transaction data for an entire year, first fraud patterns that appear at the beginning of that year but that are less prevalent at the end of that year (i.e., fraud patterns that are less likely to apply to current transactions) may be prioritized over second fraud patterns that only appear more recently but are increasing in prevalence (i.e., fraud patterns that are more likely to apply to current transitions). This prioritization is generally undesirable, at the second fraud pattern is likely much more relevant than the first fraud pattern to current transactions assessed using the computer model. Further, training the model using a relatively large dataset is computationally intensive.

Accordingly, in the embodiments described herein, the fraud scoring model is trained incrementally. Specifically, an initial dataset that includes historical transaction data for a first time period is received. The initial dataset is subsequently segmented into multiple subsets of historical transaction data. Each subset of historical transaction data is associated with a time period that is smaller than the first time period. Then, the fraud scoring model is trained on each subset of historical transaction data separately.

For example, assume the initial dataset includes historical transaction data for one year. Then, the initial dataset may be segmented into twelve subsets of historical transaction data, with each subset including historical transaction data for one month (e.g., a January subset, a February subset, etc.).

In the example embodiment, the fraud scoring model is trained on the oldest subset of data first, followed by the second oldest subset, etc. That is, in the above example, the fraud scoring model is trained on the January subset, followed by the February subset, and so on, until the fraud scoring model is trained on the December subset. Alternatively, the fraud scoring model may train on the subsets of historical transaction data in any suitable order.

Segmenting an initial dataset into multiple subsets, and then training on each subset separately improves the training (and the performance of the model). For instance, in the above example (where the initial dataset includes historical transaction data for one year and each subset includes historical transaction data for one month), instead of the model training one time on a whole year's worth of data, the model is incrementally, iteratively trained on twelve smaller subsets. By training on each month separately, the model is better able to learn (and subsequently identify) patterns that are changing from month to month. Further, when the model begins training on the February subset of data, the model has already been updated to account for the January subset of data.

In embodiments where the fraud scoring model is a gradient-boosted decision tree model, each time the fraud scoring model trains on a given subset, probabilities associated with each leaf node of the fraud scoring model are updated. That is, the historical transaction data in the current subset is used to update the leaf node probabilities on the most recently generated tree of the model, before generating a subsequent tree. This facilitates improving the accuracy of fraud scoring model 126.

This updating does require sufficient time and computational resources, and may, at least intuitively, seem unnecessary. However, significant performance gains were observed when performing incremental training with leaf node probability updates (as compared to performing incremental training without leaf node probability). Notably, performing the leaf node probability updates results in the model accounting for previously identified errors before proceeding with further training, improving the performance of the model.

For example, as described above, a computer model trained using a single, relatively large dataset may detect only approximately 3% of fraudulent transactions (due to the delay issue). When training the same computer model using incremental training with leaf node probability updates, the performance significantly improved to detecting approximately 9% of fraudulent transactions. However, when training the same computer model using incremental training without leaf node probability updates, the computer model still only detected approximately 3% of fraudulent transactions. Thus, updating leaf node probabilities when training on each subset appears to significantly improve performance.

To further improve performance, in some embodiments, the fraud scoring model is incrementally trained, but with weightings applied to at least some of the subsets based on an associated age of those subsets. As noted above, more recent historical transaction data may be less useful in training, as some fraudulent transactions within that historical transaction data may not yet have been identified. For example, a cardholder may not determine that a fraudulent transaction took place until reviewing their credit card statement days (or even weeks) after the transaction occurred. Thus, using recent, raw transaction data to train computer models for detecting fraud may impair.

Accordingly, in some embodiments of the disclosure, more recent (i.e., less aged) subsets of historical transaction data may be weighted less during training. For example, the least aged subset may be assigned a first weight factor (e.g., 5%), the second least aged subset may be assigned a second weight factor (e.g., 33%), and the third least aged subset may be assigned a third weight factor (e.g., 66%), with the remaining subsets unweighted (e.g., assigned a weight factor of 100%).

Then, when the fraud scoring model is trained on a particular subset, the associated weight factor is taken into account. For example, assume that the fraud scoring model trains on a given subset of data by iteratively generating one hundred trees using that subset. Accordingly, the fraud scoring model will iteratively generate one hundred trees on each unweighted subset. However, under the above example, the fraud scoring model will only iteratively generate sixty-six trees on the third least aged subset (i.e., 66% of one hundred), will only iteratively generate thirty-three trees on the second least aged subset (i.e., 33% of one hundred), and will only iteratively generate five trees on the least aged subset (i.e., 5% of one hundred).

Training on more recent subsets, but weighting those subsets has been observed to further improve performance of the fraud scoring model. For example, as described above, a computer model trained using a single, relatively large dataset may detect only approximately 3% of fraudulent transactions (due to the delay issue). When training the same computer model using incremental training with leaf node probability updates, the performance significantly improved to detecting approximately 9% of fraudulent transactions. Notably, when training the same computer model using increment training with leaf node probability updates, and with weighting subsets based on their associated ages, performance improved even further, resulting in detecting approximately 13% of fraudulent transactions.

The technical problems addressed by this system include at least one of: (i) undetected network-based fraud events on a payment card transaction network, especially those affecting only a subset of previously or potentially compromised payment cards; (ii) increased network load based on some types of fraud events; (iii) computational burdens imposed by automated fraud monitoring systems; and (iv) too little contrast between fraudulent transactions and legitimate transactions in some time frames to make detection possible. Other technical problems addressed by the system and methods described herein may include increased network usage (slowing down the network) due to undetected frauds (e.g., systematic attacks to determine card verification numbers through trial and error).

The methods and systems described herein may be implemented using computer programming or engineering techniques including computer software, firmware, hardware, or any combination or subset thereof, wherein the technical effects may be achieved by performing at least one of the following steps: (a) receiving, from a database, an initial dataset including historical data for a first time period, (b) segmenting the initial dataset into a plurality of subsets, each subset associated with a second time period that is smaller than the first time period, (c) training a machine learning model on each subset of the plurality of subsets separately, (d) receiving from a computing device, a candidate dataset, (e) analyzing the candidate dataset using the trained machine learning model, (f) assigning a score to the candidate dataset based on the analysis, (g) receiving the candidate dataset and the corresponding score from a model engine, and (h) generating and outputting, based at least in part on the score, a decision regarding the candidate dataset.

The resulting technical effect achieved by this system is at least one of: (i) reducing network-based fraud events through early detection; (ii) reducing network-based fraud events through multiple fraud detection methods; (iii) applying a cumulative fraud detection model to detect fraud; (iv) dynamically updating fraud models to substantially improve performance; and (vi) eliminating economic loss through, e.g., early detection and reaction to fraudulent activity. Thus, the system enables enhanced fraud detection on the payment card transaction network. Once a pattern of fraudulent activity is detected and identified, further fraudulent payment card transaction attempts may be reduced or isolated from further processing on the payment card interchange network, which results in a reduced amount of fraudulent network traffic and reduced processing time devoted to fraudulent transactions, and thus a reduced burden on the network.

As used herein, the term “database” may refer to either a body of data, a relational database management system (RDBMS), or to both. As used herein, a database may include any collection of data including hierarchical databases, relational databases, flat file databases, object-relational databases, object oriented databases, and any other structured collection of records or data that is stored in a computer system. The above examples are example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

As used herein, a “processor” may include any programmable system including systems using central processing units, microprocessors, micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In one embodiment, a computer program is provided, and the program is embodied on a computer readable medium. In an example embodiment, the system is executed on a single computer system, without requiring a connection to a server computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium.

The systems and processes are not limited to the specific embodiments described herein. In addition, components of each system and each process can be practiced independent and separate from other components and processes described herein. Each component and process can also be used in combination with other assembly packages and processes.

As used herein, the terms “payment card,” “transaction card,” and “financial transaction card” refer to any suitable payment card, such as a credit card, a debit card, a prepaid card, a charge card, a membership card, a promotional card, a frequent flyer card, an identification card, a prepaid card, a gift card, and/or any other payment device that may hold payment account information, such as mobile phones, smartphones, personal digital assistants (PDAs), key fobs, and/or computers. Each type of payment device can be used as a method of payment for performing a transaction.

As used herein, the term “fraud” is used in the context of payment card transactions and refers, generally, to an unprivileged use of a payment card. For example, a thief may steal a consumer's payment card or information from that payment card (e.g., a payment account number [PAN], expiration date, security code) and attempt to use the payment card for purchases. This type of transaction may be monitored by, for example, a fraud detection system within a payment network. Further, as used herein, a “suspected fraudulent transaction” is a payment card transaction that is suspected to be fraudulent, but which has not yet been confirmed as fraudulent by, for example, the consumer of the underlying payment card, or the issuing bank, or an analyst associated with the fraud detection system.

As used herein, the term “real-time” is used, in some contexts, to refer to a regular updating of data within a system such as the fraud detection systems, the fraud management systems, and/or the displays described herein. When a system is described as processing or performing a particular operation “in real-time,” this may mean within seconds or minutes of an occurrence of some trigger event, such as new data being generated, or on some regular schedule, such as every minute. In other contexts, some payment card transactions require “real-time” fraud operations, such as fraud scoring, which refers to operations performed during authorization of a payment card transaction (i.e., between the moment that a new payment card transaction is initiated from, for example, a merchant, and the time that an authorization decision is made, for example, back to that merchant). In such a context, “near real-time” fraud operations are operations conducted shortly after the payment card transaction has occurred (i.e., after an authorization decision is made).

The following detailed description illustrates embodiments of the disclosure by way of example and not by way of limitation. It is contemplated that the disclosure has general application to fraud management of payment card transactions.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

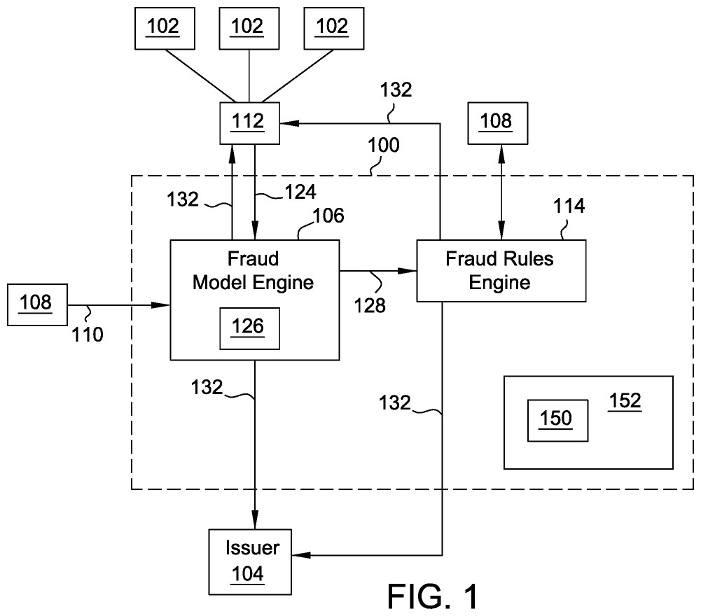

FIG. 1 is a schematic block diagram of a fraud analysis computing system 100 operating to identify fraudulent activity. For example, a particular merchant 102 may experience a data breach, such that a plurality of payment cards are compromised. That is, personally identifiable information or payment card data has been captured by fraudsters. Fraudsters may sell or use the payment card data for the compromised cards, leading to fraudulent transactions initiated using the plurality of compromised payment cards. For example, fraudsters may introduce fraudulent transactions through one or more other merchants 102 (which may or may not include the compromised merchant 102) in an attempt to deceive an issuer 104 into authorizing a transaction with a compromised payment card that is not owned and/or controlled by the person presenting the payment card at a time of purchase. Fraud analysis computing system 100 monitors transactions for fraudulent activity.

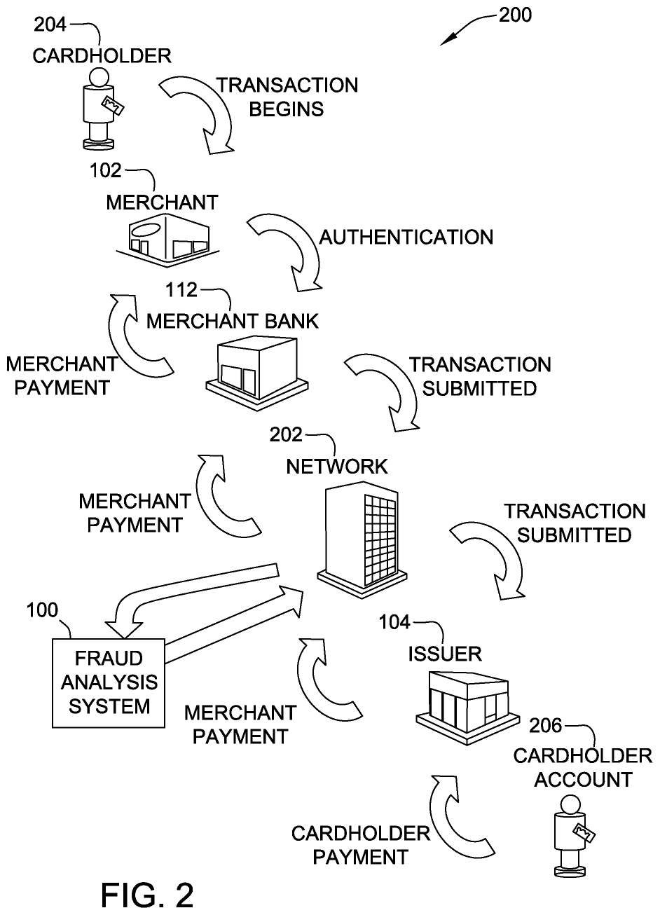

Fraudulent transactions may strain the processing and network resources of a payment card interchange network 202 (see FIG. 2). For example, some types of attempted fraud include a large number of attempted online transactions in a short period of time, which may limit a bandwidth of payment card interchange network 202 that is available for legitimate transactions. In another example, fraudulent transactions that are not detected prior to authorization by issuer 104 may result in additional activity over payment card interchange network 202 such as voids, rollbacks of cleared and settled transactions, and so forth, which may reduce processing speed and bandwidth available for legitimate transactions.

In the example embodiment, fraud analysis computing system 100 includes a fraud model engine 106. Fraud model engine 106, in the example embodiment, is communicatively coupled to at least one database 108 that stores transaction records, such as completed payment card transaction requests 110. Fraud model engine 106 may additionally or alternatively be communicatively coupled to a plurality of merchants 102 directly or through at least one merchant bank 112.

Fraud analysis computing system 100 further includes a fraud rules engine 114 communicatively coupled to database 108, and to fraud model engine 106, which is upstream from fraud rules engine 114.

In some embodiments, fraud model engine 106 and fraud rules engine 114 are implemented on the same computing platform. In alternative embodiments, each of fraud model engine 106 and fraud rules engine 114 are implemented on separate computing platforms and coupled together in electronic communication.

In the example embodiment, fraud analysis computing system 100 analyzes transaction data in real-time to determine whether transactions are potentially fraudulent, as described herein.

In the example embodiment, fraud model engine 106 is configured to receive one or more payment card transaction requests 124 from one or more merchants 102, either directly from the merchants 102 or from the at least one merchant bank 112. In various embodiments, payment card transaction requests 124 are received by payment card interchange network 202 and forwarded to fraud model engine 106. Fraud model engine 106 is configured to analyze each of the received payment card transaction requests 124 on an individual basis (that is, without regard to characteristics of other incoming payment card transaction requests) for fraud, and to assign a fraud score to each of the payment card authorization requests 124.

In one example embodiment, fraud model engine 106 executes a fraud scoring model 126 to analyze and score payment card transaction requests 124. The resulting fraud score is indicative of a likelihood of fraud being associated with a respective payment card transaction requests 124.

In some embodiments, fraud model engine 106 includes or executes a plurality of machine learning algorithms, either separate from execution of fraud scoring model 126 or as part of fraud scoring model 126. In various embodiments, the machine learning algorithms may be selectable, either automatically or by an operator, and may include at least one of an Artificial Neural Network (ANN) machine learning algorithm and a Support Vector Machine (SVM) machine learning algorithm. Fraud model engine 106 may be configured to execute multiple machine learning algorithms singly or simultaneously in groups.

At least some scored payment card transaction requests 128 are transmitted to fraud rules engine 114 for further analysis. Fraud rules engine 114 applies one or more fraud rules to each scored payment card transaction request 128 to facilitate determining whether or not the transaction is likely fraudulent. For example, the fraud rules may determine whether or not a transaction should be identified as fraudulent based on one or more of the score assigned by fraud model engine 106, a dollar amount of the transaction, a location of the transaction (e.g., whether the transaction is a cross-border transaction), a merchant involved in the transaction, etc.

Based on the analysis undertaken by fraud model engine 106 and fraud rules engine 114, fraud analysis computing system 100 generates an output 132 for each payment card transaction request 124. Output 132 may be, for example, a decision to approve or decline the transaction associated with payment card transaction request 124. In some embodiments, output 132 may include one or more scores (e.g., the fraud score assigned by fraud scoring model 126). Output 132 may be transmitted from fraud analysis computing system 100 (e.g., from fraud model engine 106 and/or fraud rules engine 114) to one or more of merchant 102, merchant bank 112, and issuer 104.

In various embodiments, fraud analysis computing system 100 further includes a graphical user interface 150 configured to display information to a user in real time through a dashboard application 152. For example, graphical user interface 150 is displayable on a display screen of a client system (not shown in FIG. 1).

Over time, fraudsters may change their tactics and/or the type of fraud attacks attempted. Accordingly, computer models for detecting fraud (such as fraud scoring model 126) may be periodically updated (or trained) to keep up with changes in fraud patterns. However, there is generally a delay between when a computer model is updated, and when that computer model is “launched” to actively monitor payment card transactions for fraud. Further, updating a computer model using relatively recent transaction data may impair the ability of the computer model to accurately detect fraud, as fraud is often discovered some period of time after the actual transaction occurs. For example, a cardholder may not determine that a fraudulent transaction took place until reviewing their credit card statement days (or even weeks) after the transaction occurred. Accordingly, using recent, raw transaction data to update computer models for detecting fraud may negatively impact the performance of those models.

As described in detail herein, to address these technical problems and improve performance for detecting fraudulent transactions, fraud scoring model 126 is trained incrementally. Specifically, instead of training a computer model all at once on a large dataset of historical transaction data covering a relatively long period of time (as is done in at least some known systems), the dataset of historical transaction data is segmented into multiple subsets of historical transaction data, and fraud scoring model 126 is trained on each subset separately. Further, in some embodiments, different subsets are weighted differently for training purposes based on their age.

In the example embodiment, fraud model engine 106 receives a payment card transaction request 124, and executes fraud scoring model 126 to analyze and score payment card transaction request 124. The resulting fraud score is indicative of a likelihood of fraud for payment card transaction request 124. For example, higher scores may indicate a higher likelihood of fraud.

In one embodiment, if the fraud score assigned by fraud model engine 106 falls below a threshold score, payment card transaction request 124 is approved without further analysis by fraud model engine 106 and fraud rules engine 114. If the fraud score meets or exceeds the threshold score, the scored payment card transaction request 124 is transmitted to fraud rules engine 114 for further analysis.

As noted above, there is generally a delay between when a computer model is trained or updated, and when that computer model is “launched” to actively monitor payment card transactions for fraud. In an ideal scenario, without such delays, at least some known computer models may detect approximately 20% of fraudulent transactions at a legitimate to fraudulent transaction ratio of 5:1 (i.e., 5 legitimate transactions are declined for every 1 fraudulent transaction that is declined). However, in reality, when the delay is implemented, at least some known computer models may only detect approximately 3% of fraudulent transactions.

Using a rules-based analysis (e.g., similar to the analysis performed by fraud rules engine 114) avoids the delay issue associated with training computer models. However, a rules-based analysis typically detects fraud at a less desirable legitimate to fraudulent transaction ratio (e.g., declining 20 legitimate transactions for every 1 fraudulent transaction that is declined). Accordingly, improving the training of the computer models, as described herein, facilitates offsetting the reducing in performance due to the delay issue, and results in a more robust and efficient fraud detection platform.

In the example embodiment, fraud scoring model 126 is a machine learning model, and more particularly, a gradient-boosted decision tree model. For example, fraud scoring model 126 may be a scalable, distributed gradient-boosted decision tree model that uses supervised machine learning, ensemble learning, and gradient boosting. In supervised machine learning, algorithms are used to train a model to find patterns in a labeled dataset, and the trained model is then used to predict labels on a new dataset. Ensemble learning includes combining different machine learning algorithms to obtain an improved output. Further, as will be appreciated by those of skill in the art, gradient boosting involves additively generating and combining weak models to generate a strong model. More specifically, gradient-boosted decision tree models iteratively train an ensemble of decision trees, and each iteration uses the error of the previous tree to fit the subsequent tree.

Alternatively, fraud scoring model 126 may be any suitable model. For example, fraud model engine 106 may employ artificial intelligence and/or be trained using supervised or unsupervised machine learning, and a machine learning program may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data. Models (e.g., fraud scoring model 126) may be created based upon example inputs in order to make valid and reliable predictions for novel inputs.

Additionally or alternatively, the machine learning programs may be trained by inputting sample data sets or certain data into the programs. The machine learning programs may utilize deep learning algorithms that may be primarily focused on pattern recognition, and may be trained after processing multiple examples. The machine learning programs may include Bayesian program learning (BPL), voice recognition and synthesis, image or object recognition, optical character recognition, and/or natural language processing-either individually or in combination. The machine learning programs may also include natural language processing, semantic analysis, automatic reasoning, and/or machine learning.

In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs.

As will be appreciated by those of skill in the art, gradient-boosted decision tree models (e.g., such as fraud scoring model 126 in the example embodiment) build a plurality of decision trees. The trees may be built sequentially or in parallel. Notably, errors or mistakes in at least some trees are used to train other trees. Further, as will be appreciated by those of skill in the art, each tree includes an initial root node, a plurality of branch nodes, and a plurality of leaf nodes.

In at least some known systems, to update computer models, the models are trained on relatively large dataset. For example, to update a fraud model, the fraud model may be trained using a dataset that includes historical transaction data covering a time period of one year. However, training the fraud model using a single, relatively large dataset may have drawbacks. For example, because the dataset includes historical transaction data for an entire year, first fraud patterns that appear at the beginning of that year but that are less prevalent at the end of that year (i.e., fraud patterns that are less likely to apply to current transactions) may be prioritized over second fraud patterns that only appear more recently but are increasing in prevalence (i.e., fraud patterns that are more likely to apply to current transitions). This prioritization is generally undesirable, at the second fraud pattern is likely much more relevant than the first fraud pattern to current transactions assessed using the computer model. Further, training the model using a relatively large dataset is computationally intensive.

Accordingly, in the embodiments described herein, fraud scoring model 126 is trained incrementally. Specifically, an initial dataset that includes historical transaction data for a first time period is received (e.g., from database 108). The initial dataset is subsequently segmented into multiple subsets of historical transaction data. Each subset of historical transaction data is associated with a time period that is smaller than the first time period. Then, fraud scoring model 126 is trained on each subset of historical transaction data separately.

For example, assume the initial dataset includes historical transaction data for one year. Then, the initial dataset may be segmented into twelve subsets of historical transaction data, with each subset including historical transaction data for one month (e.g., a January subset, a February subset, etc.).

In the example embodiment, fraud scoring model 126 is trained on the oldest subset of data first, followed by the second oldest subset, etc. That is, in the above example, fraud scoring model 126 is trained on the January subset, followed by the February subset, and so on, until fraud scoring model 126 is trained on the December subset. Alternatively, fraud scoring model 126 may train on the subsets of historical transaction data in any suitable order.

Segmenting an initial dataset into multiple subsets, and then training fraud scoring model 126 on each subset separately improves the training (and the performance of fraud scoring model 126). For instance, in the above example (where the initial dataset includes historical transaction data for one year and each subset includes historical transaction data for one month), instead of fraud scoring model 126 training one time on a whole year's worth of data, fraud scoring model 126 is incrementally, iteratively trained on twelve smaller subsets. By training on each month separately, fraud scoring model 126 is better able to learn (and subsequently identify) patterns that are changing from month to month. Further, when fraud scoring model 126 begins training on the February subset of data, fraud scoring model 126 has already been updated to account for the January subset of data.

In embodiments where fraud scoring model 126 is a gradient-boosted decision tree model, each time fraud scoring model 126 trains on a given subset, probabilities associated with each leaf node of fraud scoring model 126 are updated. That is, the historical transaction data in the current subset is used to update the leaf node probabilities on the most recently generated tree of fraud scoring model 126, before generating a subsequent tree. This facilitates improving the accuracy of fraud scoring model 126.

This updating does require sufficient time and computational resources, and may, at least intuitively, seem unnecessary. However, significant performance gains were observed when performing incremental training with leaf node probability updates (as compared to performing incremental training without leaf node probability). Notably, performing the leaf node probability updates results in fraud scoring model 126 accounting for previously identified errors before proceeding with further training, improving the performance of fraud scoring model 126.

For example, as described above, a computer model trained using a single, relatively large dataset may detect only approximately 3% of fraudulent transactions (due to the delay issue). When training the same computer model using incremental training with leaf node probability updates, the performance significantly improved to detecting approximately 9% of fraudulent transactions. However, when training the same computer model using incremental training without leaf node probability updates, the computer model still only detected approximately 3% of fraudulent transactions. Thus, updating leaf node probabilities when training on each subset appears to significantly improve performance.

To further improve performance, in some embodiments, fraud scoring model 126 is incrementally trained, but with weightings applied to at least some of the subsets based on an associated age of those subsets. As noted above, more recent historical transaction data may be less useful in training, as some fraudulent transactions within that historical transaction data may not yet have been identified. For example, a cardholder may not determine that a fraudulent transaction took place until reviewing their credit card statement days (or even weeks) after the transaction occurred. Thus, using recent, raw transaction data to train computer models for detecting fraud may impair.

Accordingly, in some embodiments of the disclosure, more recent (i.e., less aged) subsets of historical transaction data may be weighted less during training. For example, the least aged subset may be assigned a first weight factor (e.g., 5%), the second least aged subset may be assigned a second weight factor (e.g., 33%), and the third least aged subset may be assigned a third weight factor (e.g., 66%), with the remaining subsets unweighted (e.g., assigned a weight factor of 100%).

Then, when fraud scoring model 126 is trained on a particular subset, the associated weight factor is taken into account. For example, assume that fraud scoring model 126 trains on a given subset of data by iteratively generating one hundred trees using that subset. Accordingly, fraud scoring model 126 will iteratively generate one hundred trees on each unweighted subset. However, under the above example, fraud scoring model 126 will only iteratively generate sixty-six trees on the third least aged subset (i.e., 66% of one hundred), will only iteratively generate thirty-three trees on the second least aged subset (i.e., 33% of one hundred), and will only iteratively generate five trees on the least aged subset (i.e., 5% of one hundred).

Training on more recent subsets, but weighting those subsets has been observed to further improve performance of fraud scoring model 126. For example, as described above, a computer model trained using a single, relatively large dataset may detect only approximately 3% of fraudulent transactions (due to the delay issue). When training the same computer model using incremental training with leaf node probability updates, the performance significantly improved to detecting approximately 9% of fraudulent transactions. Notably, when training the same computer model using increment training with leaf node probability updates, and with weighting subsets based on their associated ages, performance improved even further, resulting in detecting approximately 13% of fraudulent transactions.

In some embodiments, as noted above, fraud analysis computer system 100 is implemented as part of, or in association with, a payment card interchange network 202. FIG. 2 is a schematic diagram illustrating an example multi-party payment card industry system 200 for enabling payment-by-card transactions involving merchants 102 and issuer banks 104. Embodiments described herein may relate to a payment card system, such as a credit card payment system using the Mastercard® interchange network. The Mastercard® interchange network is a set of proprietary communications standards promulgated by Mastercard International Incorporated® for the exchange of financial transaction data and the settlement of funds between financial institutions that are members of Mastercard International Incorporated®. (Mastercard is a registered trademark of Mastercard International Incorporated located in Purchase, New York).

In a typical payment card system, a financial institution called the “issuer” issues a payment card, such as a credit card, to a consumer or cardholder 204, who uses the payment card to tender payment for a purchase from merchant 102. To accept payment with the payment card, merchant 102 must normally establish an account with a financial institution that is part of the financial payment system. This financial institution is usually called the “merchant bank,” the “acquiring bank,” or the “acquirer.” When cardholder 204 tenders payment for a purchase with a payment card, merchant 102 requests authorization from an acquirer or merchant bank 112 for the amount of the purchase. The request may be performed over the telephone, but is usually performed through the use of a point-of-sale terminal, which reads cardholder's 204 account information from a magnetic stripe, a chip, or embossed characters on the payment card and communicates electronically with the transaction processing computers of merchant bank 112. Alternatively, merchant bank 112 may authorize a third party to perform transaction processing on its behalf. In this case, the point-of-sale terminal will be configured to communicate with the third party. Such a third party is usually called a “merchant processor,” an “acquiring processor,” or a “third party processor.”

Using payment card interchange network 202, computers of merchant bank 112 or merchant processor will communicate with computers of issuer bank 104 by sending a payment card transaction authorization request. Based on the payment card transaction authorization request, issuer 104 determines whether cardholder's 204 account 206 is in good standing and whether the purchase is covered by cardholder's 204 available credit line. Based on these determinations, the request for authorization will be declined or accepted by issuer 104. If the request is accepted, an authorization code is issued to merchant 102.

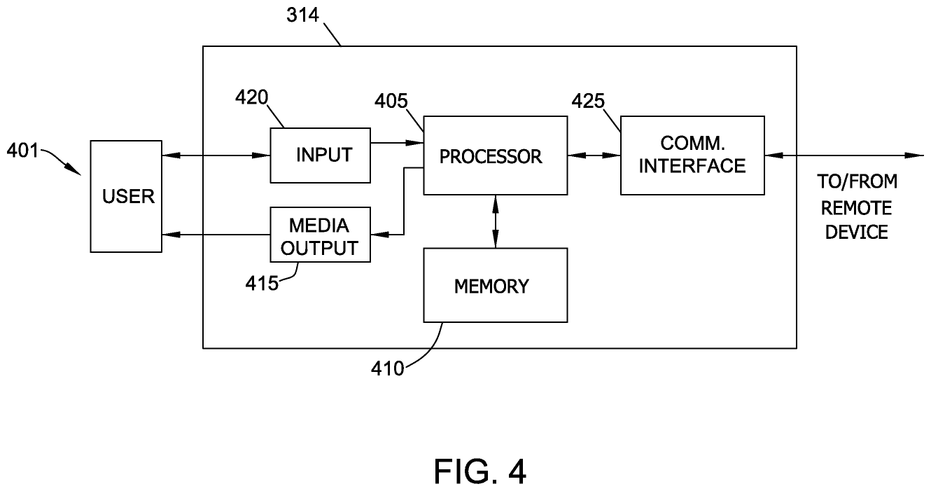

When a request for authorization is accepted, the available credit line of cardholder's 204 account 206 is decreased. Normally, a charge for a payment card transaction is not posted immediately to cardholder's 204 account 206 because bankcard associations, such as Mastercard International Incorporated®, have promulgated rules that do not allow merchant 102 to charge, or “capture,” a transaction until goods are shipped or services are delivered. However, with respect to at least some debit card transactions, a charge may be posted at the time of the transaction. When merchant 102 ships or delivers the goods or services, merchant 102 captures the transaction by, for example, appropriate data entry procedures on the point-of-sale terminal. This may include bundling of approved transactions daily for standard retail purchases. If cardholder 204 cancels a transaction before it is captured, a “void” is generated. If cardholder 204 returns goods after the transaction has been captured, a “credit” is generated. Payment card interchange network 202 and/or issuer bank 104 stores the payment card information, such as a type of merchant, amount of purchase, date of purchase, in database 108 (as shown in FIG. 4).

After a purchase has been made, a clearing process occurs to transfer additional transaction data related to the purchase among the parties to the transaction, such as merchant bank 112, payment card interchange network 202, and issuer bank 104. More specifically, during and/or after the clearing process, additional data, such as a time of purchase, a merchant name, a type of merchant, purchase information, cardholder account information, a type of transaction, itinerary information, information regarding the purchased item and/or service, and/or other suitable information, is associated with a transaction and transmitted between parties to the transaction as transaction data, and may be stored by any of the parties to the transaction.

After a transaction is authorized and cleared, the transaction is settled among merchant 102, merchant bank 112, and issuer bank 104. Settlement refers to the transfer of financial data or funds among merchant's 102 account, merchant bank 112, and issuer bank 104 related to the transaction. Usually, transactions are captured and accumulated into a “batch,” which is settled as a group. More specifically, a transaction is typically settled between issuer bank 104 and payment card interchange network 302, and then between payment card interchange network 202 and merchant bank 112, and then between merchant bank 112 and merchant 102.

In the example embodiment, payment card interchange network 202 routes payment card transaction authorization requests (such as those initiated using potentially compromised payment cards) through fraud analysis computing system 100 as described above. Detection of patterns of fraudulent activity may enable payment card interchange network 202 to identify and prevent fraudulent transactions prior to authorization by issuer 104, thereby improving transaction processing speed and bandwidth available for legitimate transactions. Fraud analysis computing system 100 may be configured to provide fraud data associated with payment card transactions to a downstream fraud management system (not shown) for further processing. Fraud analysis computing system 100 may be incorporated on one or more computing devices within payment card interchange network 202, or may be embodied in one or more separate components communicatively accessible to payment card interchange network 202.

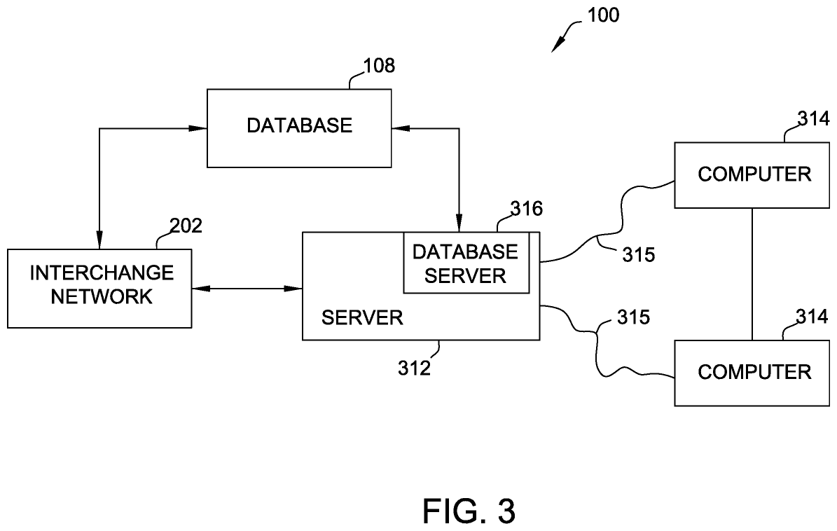

FIG. 3 is a simplified block diagram of one example of fraud analysis computing system 100 in communication with payment interchange network 202 in accordance with one embodiment of the present disclosure. In the example embodiment, fraud analysis computing system 100 is implemented on a server system 312. A plurality of client systems 314 is connected to server system 312. In one embodiment, client systems 314 are computers including a web browser, such that server system 312 is accessible to client systems 314 using the Internet. Client systems 314 are interconnected to the Internet through network connections 315, such as a local area network (LAN) or a wide area network (WAN), dial-in-connections, cable modems, special high-speed Integrated Services Digital Network (ISDN) lines, and RDT networks. Client systems 314 could be any device capable of connecting to the Internet including a web-based phone, PDA, or other web-based connectable equipment.

Server system 312 includes a database server 316 connected to database 108, which contains information on a variety of matters, as described below in greater detail. In one embodiment, database 108 is centralized on, for example, server system 312 and can be accessed by potential users at one of client systems 314 by logging onto server system 312 through one of client systems 314. In an alternative embodiment, database 108 is stored remotely from server system 312 and may be non-centralized.

Database 108 may include a single database having separated sections or partitions, or may include multiple databases, each being separate from each other. Database 108 may store transaction data generated over payment card interchange network 302 including data relating to payment card transactions, fraudulent payment card transactions, and fraud scoring values and rules. Database 108 may also store account data for a plurality of cardholders, including at least one of a cardholder name, a cardholder address, an account number, other account identifiers, and transaction information. Database 108 may also store merchant data including a merchant identifier that identifies each merchant registered to use the network, and instructions for settling transactions including merchant bank account information. Database 108 may also store purchase data associated with items being purchased by a cardholder from a merchant, and authorization request data. Database 108 may also store fraud information received from fraud analysis computing system 100.

In the example embodiment, one of client systems 314 is a user computer device associated with a user of fraud analysis computing system 100. For example, the user computer device is configured to display graphical user interface 150 (shown in FIG. 1) generated by fraud analysis computing system 100 via a web browser or dashboard application 152 (shown in FIG. 1) installed on the user computer device. Web browsers enable users of client system 314 to display and interact with media and other information typically embedded on a web page or a website associated with server system 312. Dashboard application 152 allows users to interact with a server application on server system 312.

Others of client systems 314 may be associated with acquirer or merchant bank 112 and issuer 104 (shown in FIGS. 1 and 2). In addition, client systems 314 may include a computer system associated with at least one of an online bank, a bill payment outsourcer, an acquirer bank, an acquirer processor, an issuer bank associated with a payment card, an issuer processor, a remote payment system, customers and/or billers. In the example embodiment, server system 312 is associated with payment card interchange network 202, and may be referred to as an interchange computer system. Server system 312 may be used for general processing of payment card transaction data as well as analyzing fraud data associated with payment card transactions.

FIG. 4 illustrates an example configuration of one of client systems 314 operated by a user 401, such as an analyst. In the example embodiment, client system 314 includes a processor 405 for executing instructions. In some embodiments, executable instructions are stored in a memory area 410. Processor 405 may include one or more processing units, for example, a multi-core configuration. Memory area 410 is any device allowing information such as executable instructions and/or written works to be stored and retrieved. Memory area 410 may include one or more computer readable media.

Client system 314 also includes at least one media output component 415 for presenting information to user 401. Media output component 415 is any component capable of conveying information to user 401. For example, media output component is configured to display graphical user interface 150 (shown in FIG. 1) to user 401. In some embodiments, media output component 415 includes an output adapter such as a video adapter and/or an audio adapter. An output adapter is operatively coupled to processor 405 and operatively coupleable to an output device such as a display device, a liquid crystal display (LCD), organic light emitting diode (OLED) display, or “electronic ink” display, or an audio output device, a speaker or headphones.

In some embodiments, client system 314 includes an input device 420 for receiving input from user 401. Input device 420 may include, for example, a keyboard, a pointing device, a mouse, a stylus, a touch sensitive panel, a touch pad, a touch screen, a gyroscope, an accelerometer, a position detector, or an audio input device. A single component such as a touch screen may function as both an output device of media output component 415 and input device 420. Client system 314 may also include a communication interface 425, which is communicatively coupleable to a remote device such as server system 312. Communication interface 425 may include, for example, a wired or wireless network adapter or a wireless data transceiver for use with a mobile phone network, Global System for Mobile communications (GSM), 3G, or other mobile data network or Worldwide Interoperability for Microwave Access (WIMAX).

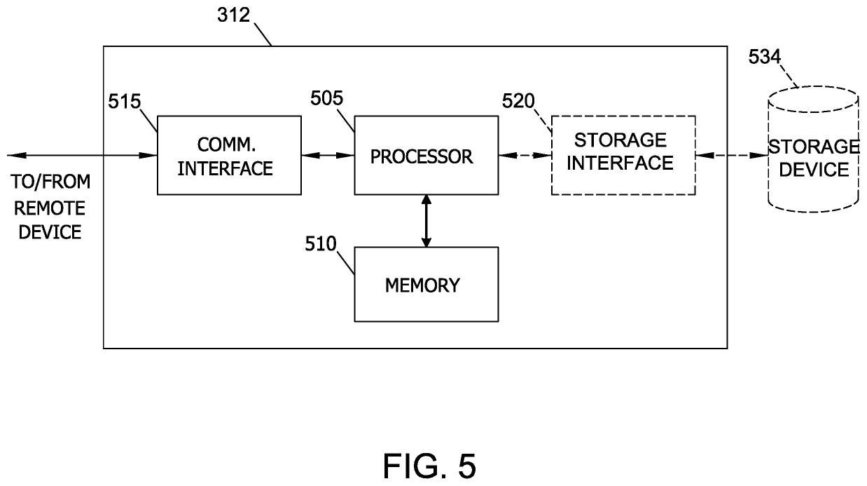

FIG. 5 illustrates an example configuration of server system 312. Server system 312 includes a processor 505 for executing instructions. Instructions may be stored in a memory area 510, for example. Processor 505 may include one or more processing units (e.g., in a multi-core configuration) for executing instructions. The instructions may be executed within a variety of different operating systems on the server system 312, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 505 is operatively coupled to a communication interface 515 such that server system 312 is capable of communicating with remote devices such as client systems 314 (shown in FIG. 3) or another server system 312. For example, communication interface 515 may receive requests from client system 314 via the Internet, as illustrated in FIG. 3.

Processor 505 may also be operatively coupled to a storage device 534, which may be used to implement database 108. Storage device 534 is any computer-operated hardware suitable for storing and/or retrieving data. In some embodiments, storage device 534 is integrated in server system 312. For example, server system 312 may include one or more hard disk drives as storage device 534. In other embodiments, storage device 534 is external to server system 312 and may be accessed by a plurality of server systems 312. For example, storage device 534 may include multiple storage units such as hard disks or solid state disks in a redundant array of inexpensive disks (RAID) configuration. Storage device 534 may include a storage area network (SAN) and/or a network attached storage (NAS) system.

In some embodiments, processor 505 is operatively coupled to storage device 534 via a storage interface 520. Storage interface 520 is any component capable of providing processor 505 with access to storage device 534. Storage interface 520 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 505 with access to storage device 534.

Memory area 510 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

In operation, fraud analysis computing system 100 (shown in FIG. 1) runs on server system 312. In some embodiments, at least one of fraud model engine 106 and fraud rules engine 114 run on the same server system 312. Alternatively, each of first fraud detection module fraud model engine 106 and fraud rules engine 114 run on separate server systems 312 communicatively coupled to each other. User 401 (shown in FIG. 4) interacts with server system 312, and with modules such as fraud model engine 106 and fraud rules engine 114 using one of client systems 314 (shown in FIG. 4).

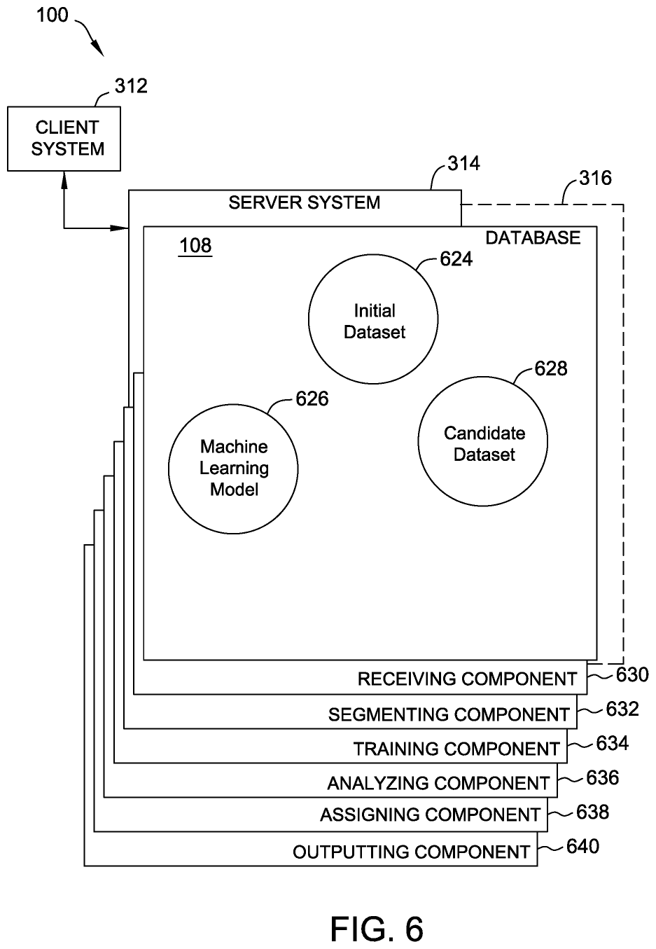

FIG. 6 shows an example configuration of fraud analysis computing system 100. Database 108 is coupled to several separate components within fraud analysis computing system 100, which perform specific tasks. In the example embodiment, server system 312, database server 316, and database 108 are all contained in a single computing device. In other embodiments, server system 312, database server 316, and database 108 may be contained in separate computing devices which are communicatively coupled to each other. In this embodiment, database 108 includes an initial dataset 624, a machine learning model 626, and a candidate dataset 628. In other embodiments, database 108 may include any suitable data structures.

Computing system 100 includes a receiving component 630 for receiving initial dataset 624 and for receiving candidate dataset 628. Computing system 100 further includes a segmenting component 632 for segmenting initial dataset 624 into a plurality of subsets, as described herein. Computing system 100 further includes a training component 634 for training machine learning model 626, as described herein. Computing system 100 further includes an analyzing component 636 for analyzing candidate dataset 628 using trained machine learning model 626. Computing system 100 further includes an assigning component 638 for assigning a score to candidate dataset 628. Computing system further includes an outputting component 640 for generating an outputting a decision, as described herein.

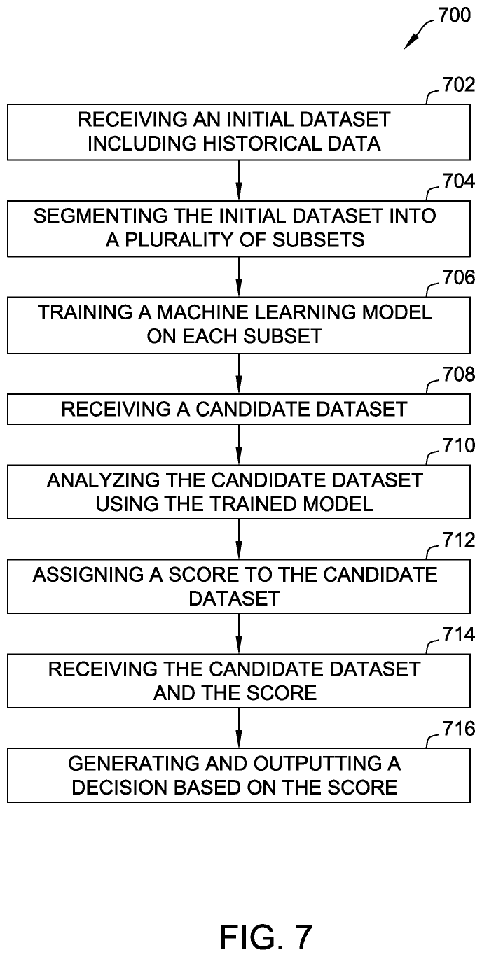

FIG. 7 is a flow diagram of a computer-implemented method 700 for training a fraud model and detecting fraudulent network transactions in a payment card transaction network. Method 700 uses at least one computing device, such as fraud analysis computing system 100. The at least one computing device has at least one processor, such as processor 116, and the at least one processor performs the steps of method 700.

In this embodiment, method 700 includes receiving 702, from a database, an initial dataset including historical data for a first time period. Method 700 further includes segmenting 704 the initial dataset into a plurality of subsets, each subset associated with a second time period that is smaller than the first time period. Method 700 further includes training 706 a machine learning model on each subset of the plurality of subsets separately. Method 700 further includes receiving 708, from a computing device, a candidate dataset. Method 700 further includes analyzing 710 the candidate dataset using the trained machine learning model. Method 700 further includes assigning 712 a score to the candidate dataset based on the analysis. Method 700 further includes receiving 714 the candidate dataset and the corresponding score. Method 700 further includes generating and outputting 716, based at least in part on the score, a decision regarding the candidate dataset.

As used herein, “machine learning” refers to statistical techniques to give computer systems the ability to “learn” (e.g., progressively improve performance on a specific task) with data, without being explicitly programmed for that specific task.

As will be appreciated based on the foregoing specification, the above-discussed embodiments of the disclosure may be implemented using computer programming or engineering techniques including computer software, firmware, hardware or any combination or subset thereof. Any such resulting program, having computer-readable and/or computer-executable instructions, may be embodied or provided within one or more computer-readable media, thereby making a computer program product, i.e., an article of manufacture, according to the discussed embodiments of the disclosure. The computer readable media may be, for instance, a fixed (hard) drive, diskette, optical disk, magnetic tape, semiconductor memory such as read-only memory (ROM) or flash memory, etc., or any transmitting/receiving medium such as the Internet or other communication network or link. The article of manufacture containing the computer code may be made and/or used by executing the instructions directly from one medium, by copying the code from one medium to another medium, or by transmitting the code over a network.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as firmware, physical and virtual storage, CD-ROMs, DVDs, and any other digital source such as a network or the Internet, as well as yet to be developed digital means, with the sole exception being a transitory, propagating signal.

As used herein, the term “computer” and related terms, e.g., “computing device”, are not limited to integrated circuits referred to in the art as a computer, but broadly refers to a microcontroller, a microcomputer, a programmable logic controller (PLC), an application specific integrated circuit, and other programmable circuits, and these terms are used interchangeably herein.

As used herein, the term “cloud computing” and related terms, e.g., “cloud computing devices” refers to a computer architecture allowing for the use of multiple heterogeneous computing devices for data storage, retrieval, and processing. The heterogeneous computing devices may use a common network or a plurality of networks so that some computing devices are in networked communication with one another over a common network but not all computing devices. In other words, a plurality of networks may be used in order to facilitate the communication between and coordination of all computing devices.

As used herein, the term “mobile computing device” refers to any computing device which is used in a portable manner including, without limitation, smart phones, personal digital assistants (“PDAs”), computer tablets, hybrid phone/computer tablets (“phablet”), or other similar mobile device capable of functioning in the systems described herein. In some examples, mobile computing devices may include a variety of peripherals and accessories including, without limitation, microphones, speakers, keyboards, touchscreens, gyroscopes, accelerometers, and metrological devices. Also, as used herein, “portable computing device” and “mobile computing device” may be used interchangeably.

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

This written description uses examples to illustrate the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A computing system for detecting patterns in data transmitted over a network, said computing system comprising:
a model engine configured to:
receive, from a database, an initial dataset including historical data for a first time period;
segment the initial dataset into a plurality of subsets, each subset associated with a second time period that is smaller than the first time period;
train a machine learning model on each subset of the plurality of subsets separately;
receive, from a computing device, a candidate dataset;
analyze the candidate dataset using the trained machine learning model; and
assign a score to the candidate dataset based on the analysis; and
a rules engine communicatively coupled to the model engine and configured to:
receive the candidate dataset and the corresponding score from the model engine; and
generate and output, based at least in part on the score, a decision regarding the candidate dataset.

2. The computing system of claim 1, wherein the machine learning model is a gradient-boosted decision tree model.

3. The computing system of claim 1, wherein to train the machine learning model, the model engine is configured to update probabilities associated with each leaf node of the machine learning model when training on each subset.

4. The computing system of claim 1, wherein to train the machine learning model, the model engine is configured to train the machine learning model on an oldest subset first.

5. The computing system of claim 1, wherein the first time period is one year, and wherein each second time period is one month.

6. The computing system of claim 1, wherein the machine learning model is a fraud scoring model.

7. A computing system for detecting and preventing fraudulent network events in a payment card network, said computing system comprising:
a fraud model engine configured to:
receive, from a database, an initial dataset including historical transaction data for a first time period;
segment the initial dataset into a plurality of subsets, each subset associated with a second time period that is smaller than the first time period;
train a fraud scoring model on each subset of the plurality of subsets separately;
receive, from a merchant computing device, a payment card transaction request;
analyze the payment card transaction request using the trained fraud scoring model; and
assign a score to the payment card transaction request based on the analysis; and
a fraud rules engine communicatively coupled to the fraud model engine and configured to:
receive the payment card transaction request and the corresponding score from the fraud model engine; and
generate and output, based at least in part on the score, a decision whether to approve or decline a transaction associated with the payment card transaction request.

8. The computing system of claim 7, wherein the fraud scoring model is a machine learning model.

9. The computing system of claim 7, wherein the fraud scoring model is a gradient-boosted decision tree model.

10. The computing system of claim 7, wherein to train the fraud scoring model, the fraud model engine is configured to update probabilities associated with each leaf node of the fraud scoring model when training on each subset.

11. The computing system of claim 7, wherein to train the fraud scoring model, the fraud model engine is configured to train the fraud scoring model on an oldest subset first.

12. The computing system of claim 7, wherein the first time period is one year, and wherein each second time period is one month.

13. The computing system of claim 7, wherein the fraud scoring model is a supervised machine learning model.

14. A computer-implemented method for detecting and preventing fraudulent network events in a payment card network, said method comprising:
receiving, at a fraud model engine, from a database, an initial dataset including historical transaction data for a first time period;
segmenting the initial dataset into a plurality of subsets, each subset associated with a second time period that is smaller than the first time period;
training a fraud scoring model on each subset of the plurality of subsets separately;
receiving, from a merchant computing device, a payment card transaction request;
analyzing the payment card transaction request using the trained fraud scoring model;
assigning a score to the payment card transaction request based on the analysis;
receiving, at a fraud rules engine communicatively coupled to the fraud model engine, the payment card transaction request and the corresponding score from the fraud model engine; and
generating and outputting, based at least in part on the score, a decision whether to approve or decline a transaction associated with the payment card transaction request.

15. The method of claim 14, wherein the fraud scoring model is a machine learning model.

16. The method of claim 14, wherein the fraud scoring model is a gradient-boosted decision tree model.

17. The method of claim 14, wherein training the fraud scoring model comprises updating probabilities associated with each leaf node of the fraud scoring model when training on each subset.

18. The method of claim 14, wherein training the fraud scoring model comprises training the fraud scoring model on an oldest subset first.

19. The method of claim 14, wherein the first time period is one year, and wherein each second time period is one month.

20. The method of claim 14, wherein the fraud scoring model is a supervised machine learning model.
